(19) United States
(12) Patent Application Publication
(10) Pub. No.: US 2008/0308767 A1
(43) Pub. Date: Dec. 18, 2008

(54) INCREASING THE STABILITY OF LIQUID HYPOCHLORITE-CONTAINING WASHING AND CLEANING COMPOSITIONS

(76) Inventors: Carlos MALET, Barcelona (ES); Carlos PEREZ, Barcelona (ES); Miguel OSSET, Sant Pere de Vilamajor (ES)

Correspondence Address: PAUL & PAUL, 2000 MARKET STREET, Suite 2900, PHILADELPHIA, PA, 19103-3229, US

(21) Appl. No.: 12/132,263

(22) Filed: Jun. 3, 2008

Related U.S. Application Data
(63) Continuation of application No. PCT/EP2006/010743, filed on Nov. 9, 2006.

(30) Foreign Application Priority Data
Dec. 7, 2005 (DE) 10 2005 058 642.2

(51) Int. Cl. C11D 7/54; C01B 11/06

(52) U.S. Cl. 252/186.25

(57) ABSTRACT

The improvement of shelf stability in hypochlorite-containing aqueous liquid washing and/or cleaning agents that contain colored metal pigment is achieved by the use of a specific aromatic fragrance.

### CROSS-REFERENCE TO RELATED APPLICATIONS

This application is a continuation under 35 U.S.C. Section 365(c) and 35 U.S.C. Section 120 of International Application No. PCT/EP2006/010743, filed Nov. 9, 2006. This application also claims priority under 35 U.S.C. Section 119 of German Patent Application No. DE 10 2005 058 642.2, filed Dec. 7, 2005. Both the International Application and the German Application are incorporated herein by reference in their entireties.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

The present invention relates to the stabilization of hypochlorite-containing liquid washing agents and/or cleaning agents for hard surfaces in households, for example, for cleaning tiles.

Sodium hypochlorite is known as a highly effective bleaching agent, and has been used for a long time, if applicable together with soaps and/or synthetic surfactants, for removing spots and all kinds of stains when laundering textiles, and also for the cleaning of hard surfaces. For household use it is normally marketed in concentrations from approximately 2 wt % to 10 wt % in water.

Liquid washing-agent preparations, or corresponding preparations of cleaning agents for hard surfaces, that contain hypochlorite as a bleach component are susceptible to a loss in activity when stored for a long period, in particular, because of the decomposition of the hypochlorite that then occurs. Also among the ingredients that are desired in washing and cleaning agents from application standpoints or for aesthetic reasons, in addition to the active substances (in this case especially the hypochlorite) that critically influence the performance of such agents, are coloring agents that are intended to give liquid preparations, in particular, a pleasant visual appearance. Dyes, in particular, are as a general rule easily oxidatively attacked by hypochlorite, so that in addition to loss of the bleaching agent, the color impression of hypochlorite-containing liquid agents also changes rapidly during storage. The same applies to fragrances, which in numerous cases are attacked by the hypochlorite as a strong oxidizing agent, so that the fragrance impression of perfumed agents changes, in an often unacceptable fashion, during storage.

Although there are several proposals for stabilizing alkali hypochlorite in aqueous systems, alternative approaches to a solution are nevertheless worth investigating.

(2) Description of Related Art, Including Information Disclosed Under 37 C.F.R. Sections 1.97 and 1.98.

European Patent Application EP 0 903 403, for example, suggests the use of an alkyl(alkoxy)ₙ sulfate (where n=0.5 to 20), which must contain only small proportions of unsulfated material and very small proportions of metal contaminants, to increase the chemical stability of liquid bleaching agents that contain a hypohalite. It is known from International Patent Application WO 99/28427 that substituted benzenes which comprise an OCH₃ or CH═CHCOOM substituent (where M is hydrogen, an alkali metal, or ammonium), and if applicable up to three further substituents OH, COOM, OCH₃, CH₃, CHO, CH₂OH, COOCH₃, COOC₁₋₄H₃₋₉, C₁₋₄H₃₋₉, OCOCH₃, or NH₂, or mixtures thereof, can be utilized in quantities from 0.001 wt % to 10 wt % as rheology-stabilizing active substances in thickened aqueous compositions that contain 0.1 wt % to 50 wt % alkali hypohalite, 0.01 wt % to 10 wt % polymeric rheology modifier, alkaline buffer ingredient for a pH from 2 to 4, and water as the remainder.

### BRIEF SUMMARY OF THE INVENTION

It has now been found, surprisingly, that certain aromatic fragrances in aqueous liquid washing and cleaning agents have a pronounced stabilizing effect both on hypochlorite and on color pigments that otherwise would normally be quickly decomposed in such agents by the hypochlorite.

### BRIEF DESCRIPTION OF THE SEVERAL VIEWS OF THE DRAWING(S)

Not Applicable

### DETAILED DESCRIPTION OF THE INVENTION

The subject matter of the invention is, therefore, the use of p-methyoxybenzyl alcohol for the stabilization of hypochlorite-containing aqueous liquid compositions that contain colored metal pigment.

As a further advantage, it has been observed that as a result of a synergistic effect between the fragrance and alkali iodides, larger quantities of dyes than would otherwise be possible can be incorporated into hypochlorite-containing agents.

A second subject of the invention is, therefore, the combined use of p-methoxybenzyl alcohol and an alkali iodide for stabilizing hypochlorite-containing aqueous liquid compositions that contain colored metal pigment.

A further subject of the invention is an aqueous liquid bleaching agent, containing alkali hypochlorite and colored metal pigment, which is characterized in that it additionally contains p-methoxybenzyl alcohol, if applicable in combination with alkali iodide.

p-Methoxybenzyl alcohol is also referred to as anise alcohol. It can be obtained commercially and is therefore used, for example, as a component of fragrance mixtures.

It is normally sufficient if more than 0 wt % up to approximately 0.5 wt %, in particular, approximately 0.01 wt % to approximately 0.1 wt %, p-methoxybenzyl alcohol is contained in the liquid agent to be stabilized.

In a preferred embodiment, the liquid agent stabilized in accordance with the invention contains 0.5 wt % to 5 wt % alkali hypochlorite, in particular, sodium hypochlorite.

Preparations of this kind are particularly suitable and very effective as cleaning agents for hard surfaces, for example, for use on walls, work surfaces, floors, and the like. Substantially because of their hypochlorite content, the agents are particularly suitable for removing stains such as those that occur in kitchens or bathrooms, including the grimy stains that can occur after bathtubs, shower stalls, and washbasins are used.

A bleaching agent in the form of hypochlorite is an essential constituent of the agents according to the present invention. Bleaching agents per se are entirely known components of cleaning-agent compositions, and are particularly successful for combating mildew and mold, stains that are often encountered in soap deposits or together with them. Although other alkali hypochlorites such as, for example, potassium hypochlorite may be used, it is nevertheless preferred to use sodium hypochlorite in agents stabilized according to the present invention. Commercially usual aqueous sodium hypochlorite solutions often contain considerable quantities of chloride salts. The latter can certainly be used for the manufacture of agents according to the present invention, so that it is not absolutely necessary to use high-purity NaOCl. In a preferred embodiment of the invention, the agents contain 0.5 wt % to 4.5 wt %, in particular 1 wt % to 4 wt %, alkali hypochlorite.

The agents preferably contain more than 0 wt % to approximately 0.01 wt %, in particular, approximately 0.001 wt % to approximately 0.008 wt %, colored, in particular, blue and/or green, metal pigment. Preferred are complex compounds of nickel, cobalt, copper, iron, and/or manganese; copper phthalocyanine dyes are particularly preferred.

The stability of both the colored metal pigment and the alkali hypochlorite is elevated by the presence of alkali iodide. By preference, more than 0 wt % up to approximately 0.01 wt %, in particular, approximately 0.001 wt % to approximately 0.006 wt %, alkali iodide, in particular, potassium iodide, is present.

The agents stabilized according to the present invention are normally alkaline, and for that purpose can contain approximately 0.1 wt % to 2 wt %, in particular, 0.1 wt % to 1.1 wt %, alkali hydroxide. The preferred alkali hydroxide is sodium hydroxide, and the alkali salts that are recited in conjunction with the other ingredients of the agents are also preferably the sodium salts.

The preparations can contain surfactants that are stable in the presence of the hypochlorite. Betaines are preferred, in particular of the general formula (I)

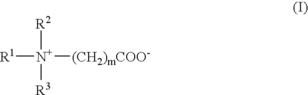

in which R¹ is an alkyl or alkenyl group having 6 to 22 carbon atoms or an R⁴CO—NH—(CH₂)ₙ group, R² is hydrogen or an alkyl group having 1 to 4 carbon atoms, R³ is hydrogen or an alkyl group having 1 to 4 carbon atoms, R⁴ is an alkyl or alkenyl group having 6 to 22 carbon atoms, m is a number from 1 to 6, and n is a number from 1 to 3.

Examples of particularly suitable representatives of this class of surfactants encompass C₁₂₋₁₈-alkyl dimethyl betaine, commercially obtainable as coco betaine, and C₁₀₋₁₆-alkyl dimethyl betaine, commercially obtainable as lauryl betaine. A further class of particularly preferred surfactants are the alkyl ether sulfates, which are obtainable by reacting alcohols (preferably having 6 to 22 carbon atoms) with alkylene oxides, in particular, ethylene oxide, and subsequent sulfatizing and neutralization, in particular, a C₁₂₋₁₄ fatty alcohol ether sulfate alkoxylated with 2 equivalents of ethylene oxide. The corresponding cation in the ether sulfates is preferably sodium. Surfactants, if present, are preferably contained in quantities of up to 5 wt %, in particular from 0.01 wt % to 3 wt %, in agents stabilized according to the present invention.

The preparations can additionally contain sequestering agents, by preference alkylphosphonic acids, and among the latter especially those having at least one amine oxide substituent on the alkyl group (referred to here as amine oxide phosphonic acids), polyacrylic acids, and/or polyacrylic acids comprising phosphono groups, which acids can also be present in the form of their alkali salts. The incorporation of such complexing agents results, surprisingly, in a particularly good shine on treated hard surfaces. This is not observed when other complexing agents, for example, methylglycinediacetic acid or nitrilotriacetic acid, are used instead. Amine oxide phosphonic acids are normally manufactured by oxidation of aminoalkylphosphonic acids. They preferably belong to the group of compounds according to the general formula (II)

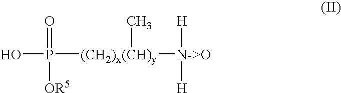

in which R⁵ is hydrogen, a —(CH₂)ₓ(CHCH₃)_{y}—NH₂->O group, or an alkali metal, x is a number from 1 to 4, and y is 0 or 1.

Among the particularly preferred amine oxide phosphonic acids is the amine oxide based on aminotrimethylenephosphonic acid. By preference, 0.01 wt % to 2 wt % of such sequestering agents is present.

In addition to the aforementioned constituents, the preparations stabilized according to the present invention can contain small quantities of one or more bleach-stable odorants. The fragrance component contained, if applicable, in addition to the anise alcohol is preferably of higher relative volatility than the constituents that are responsible, if applicable, for imparting a bleach smell.

The agents stabilized according to the present invention can easily be manufactured by mixing the aforementioned ingredients in the quantities indicated.

### EXAMPLES

Preparations according to the present invention (I1, I2) having various levels of pigment content, and preparations of otherwise identical compositions for comparison purposes without anise alcohol and potassium iodide (C1, C2), were produced by mixing the ingredients with water. The compositions of the agents were as follows (wt %):

TABLE 1
Compositions.

| | I1 | I2 | C1 | C2 |
|---|---|---|---|---|
| Sodium hypochlorite | 3.4 | 3.4 | 3.4 | 3.4 |
| C_{12/14} fatty alcohol 2 EO | 1.25 | 1.25 | 1.25 | 1.25 |
| sulfate, sodium salt | | | | |
| Anise alcohol | 0.08 | 0.08 | — | — |
| Potassium iodide | 0.004 | 0.004 | — | — |
| Copper phthalocyanine, blue | 0.002 | 0.005 | 0.002 | 0.005 |
| Sodium hydroxide | 1 | 1 | 1 | 1 |
| Aminotrimethylenephosphonic | 0.1 | 0.1 | 0.1 | 0.1 |
| acid N-oxide | | | | |
| Water | to make | to make | to make | to make |
| | 100 | 100 | 100 | 100 |

All the agents were placed into plastic bottles and stored for 12 weeks at 20° C. After storage, the hypochlorite content was distinctly higher in the preparations according to the present invention than in the preparations tested for comparison:

TABLE 2
Residual NaClO content after storage (as % of original content).

| Agent | NaClO |
|---|---|
| C1 | 46 |
| C2 | 28 |
| I1 | 90 |
| I2 | 88 |

1. A process for stabilizing a hypochlorite-containing aqueous liquid composition that contains colored metal pigment, comprising the step of mixing p-methoxybenzyl alcohol with the composition.

2. A process for stabilizing a hypochlorite-containing aqueous liquid composition that contains colored metal pigment, comprising the step of mixing a combination of p-methoxybenzyl alcohol and an alkali iodide with the composition.

3. The process according to claim 1, wherein the composition contains more than 0 wt % to 0.5 wt % p-methoxybenzyl alcohol.

4. The process according to claim 2, wherein the composition contains more than 0 wt % to 0.01 wt % potassium iodide.

5. The process according to claim 1, wherein the composition contains more than 0 wt % to 0.01 wt % colored metal pigment.

6. The process according to claim 5, wherein the metal pigment is a copper phthalocyanine dye.

7. The process according to claim 1, wherein the composition contains 0.5 wt % to 5 wt % alkali hypochlorite.

8. The process according to claim 1, wherein the composition contains up to 5 wt % bleach-stable surfactant.

9. The process according to claim 1, wherein the composition contains 0.01 wt % to 2 wt % of an acid or salt selected from the group consisting of alkylphosphonic acid, alkylphosphonate, amine oxide phosphonic acid, polyacrylic acid, polyacrylic acid containing phosphono groups, and/or an alkali salt of one, two or all three of said acids.

10. An aqueous liquid bleaching agent containing alkali hypochlorite, colored metal pigment, and p-methoxybenzyl alcohol.

11. The agent according to claim 10, wherein the agent additionally contains alkali iodide.

12. The agent according to claim 10, wherein the agent contains more than 0 wt % to 0.5 wt % p-methoxybenzyl alcohol.

13. The agent according to claim 11, wherein the agent contains more than 0 wt % to 0.01 wt % potassium iodide.

14. The agent according to claim 10 wherein the agent contains more than 0 wt % to 0.01 wt % colored metal pigment.

15. The agent according to claim 14, wherein the metal pigment is a copper phthyalocyanine dye.

16. The agent according to claim 10, wherein the agent contains 0.5 wt % to 5 wt % alkali hypochlorite.

17. The agent according to claim 10, wherein the agent contains up to 5 wt % bleach stable surfactant.

18. The agent according to claim 10, wherein the agent contains 0.01 wt % to 2 wt % of an acid or salt selected from the group consisting of alkylphosphonic acid, alkylphosphate, amine oxide phosphonic acid, polyacrylic acid, polyacrylic acid containing phosphono groups, and/or an alkali salt of one, two or all three of said acids.

19. The agent according to claim 10, wherein the alkali hypochlorite is sodium hypochlorite and the colored metal pigment is copper phthalocyanine blue.

20. The agent according to claim 19, wherein the agent additionally contains potassium iodide.
